(19) United States
(12) Patent Application Publication
(10) Pub. No.: US 2011/0285049 A1
(43) Pub. Date: Nov. 24, 2011

(54) CARBON NANOTUBE (CNT)-ENHANCED PRECURSOR FOR CARBON FIBER PRODUCTION AND METHOD OF MAKING A CNT-ENHANCED CONTINUOUS LIGNIN FIBER

(76) Inventors: Frederick S. Baker, Oak Ridge, TN (US); Darren A. Baker, Kingston, TN (US); Paul A. Menchhofer, Clinton, TN (US)

(21) Appl. No.: 12/783,288

(22) Filed: May 19, 2010

(51) Int. Cl. B29C 47/06; H01B 1/24; C09K 5/00

(52) U.S. Cl. 264/105; 252/73; 252/511; 264/173.16; 977/742

(57) ABSTRACT

A precursor for carbon fiber production comprises a continuous lignin fiber including carbon nanotubes dispersed therein at a concentration of about 10 wt. % or less. A method of melt-spinning a continuous lignin fiber includes preparing a melt comprising molten lignin and a plurality of carbon nanotubes, and extruding the melt through a spinneret to form a continuous lignin fiber having the carbon nanotubes dispersed therein.

### FEDERALLY SPONSORED RESEARCH OR DEVELOPMENT

Pursuant to contract no. DE-AC05-000R22725 between the United States Department of Energy and UT-Battelle, LLC, the United States Government may have certain rights in this invention.

### TECHNICAL FIELD

The present disclosure is related generally to natural polymer fibers and more particularly to lignin fibers that may used as precursors for carbon fiber production.

### BACKGROUND

Carbon fibers and composites containing carbon fibers are employed throughout the composites industry and are being used in a diverse breadth of products from light-weight structural materials for automotive, aviation, and military applications, to sports equipment including bicycles, fishing rods and tennis rackets. The paramount need to reduce costs for current carbon fibers has sparked research to develop a lower cost technology. As carbon fiber costs fall, the market will continue to expand into additional applications for consumers.

Improving the properties of carbon fibers would benefit varied technology applications. For example, carbon fibers with substantially improved electrical conductivity could be exploited by the airline industry to provide a means for an aircraft to bleed off a lightning charge when struck.

For the automotive industry, carbon fiber-resin composite materials could substantially reduce the weight of passenger vehicles, increase vehicle fuel economy, and result in lower CO₂ emissions. Carbon fibers have the potential for substantial weight savings in vehicles because of their remarkably high strength, high modulus, and low density; each 10% reduction in vehicle weight could translate into an increase in vehicle fuel economy of about 6%, with a concomitant reduction in emissions. To place the potential increase in fuel economy into perspective, body-in-white modeling indicates that more than 60% of the steel in a vehicle could be replaced with carbon fiber composite materials without impacting vehicle crashworthiness. However, carbon fiber is currently too expensive for large scale automotive use. A large reduction in cost of appropriate-strength fiber is needed before carbon fiber makes significant gains in the automotive industry. Currently, the cost of the precursor material accounts for about 50% of the cost of manufacturing carbon fibers, and thus the development of a low cost carbon fiber precursor material is desired. The price point at which vehicle manufacturers could utilize substantial amounts of carbon fiber in vehicles is $5-7/lb.

Lignin is one of the main components of all vascular plants and the second most abundant polymer in nature (after cellulose). This natural polymer is being explored for use as a precursor material for carbon fiber production. Chemical pulping of wood is the primary source of lignin currently in the U.S., but as biomass refineries come on-stream, the lignin by-product from cellulosic ethanol fuel production may be a valuable resource material for carbon-fiber production. Work on biomass lignins produced from the organosolv pulping of wood, the first step in cellulosic ethanol production, has shown that such lignins are readily melt-spinnable as isolated and are of a much higher purity level than lignins derived from the chemical pulping of wood for paper production.

The properties of lignin as a polymer and as a precursor material for carbon fiber production are very different from those of conventional synthetic polymers, such as polyacrylonitrile (PAN), which is used as a precursor for the vast majority—over 90%—of all carbon fibers produced today. PAN precursor fibers are made using an expensive wet (solvent-based) process that involves many stages of washing to remove residual traces of solvent and also requires solvent recovery and purification operations. Melt spinning of a precursor fiber is much preferred over the wet-spinning process, but currently is used only in the spinning of pitch-based carbon fibers, which account for a relatively small proportion of worldwide carbon-fiber production. PAN cannot be melt spun, at least as formulated to achieve the engineering requirements of PAN-based carbon fibers, because it rapidly decomposes close to its melting point.

Lignin, which may be melt spun, has a significant potential cost advantage over even textile-grade PAN as a precursor material for carbon fiber production. Whereas the cost of PAN is almost directly proportional to the cost of oil, the cost of lignin is largely independent of oil price, essentially being based on its fuel value of about $0.05/lb. On the downside, however, the process of transforming lignin into carbon fiber is not as well understood as the PAN conversion process, and challenges remain in the melt spinning of lignin.

### BRIEF SUMMARY

An improved precursor for carbon fiber production and a method of making a continuous lignin fiber are described herein. The precursor comprises a continuous lignin fiber including carbon nanotubes dispersed therein at a concentration of about 10 wt. % or less.

The method of making a continuous lignin fiber includes preparing a melt comprising molten lignin and a plurality of carbon nanotubes, and extruding the melt through a spinneret to form a continuous lignin fiber having the carbon nanotubes dispersed therein.

### BRIEF DESCRIPTION OF THE DRAWINGS

FIG. 1A shows the chemical structure of lignin isolated from beech hardwood;

FIG. 1B shows the chemical structure of lignin isolated from a softwood;

FIG. 2 is a schematic of an exemplary melt spinning apparatus and process to form a continuous fiber; and

FIGS. 3A and 3B are scanning electron microscope (SEM) images taken at different magnifications showing a fracture surface of a lignin fiber (about 24 microns in diameter) spun from a lignin material including carbon nanotubes dispersed therein.

### DETAILED DESCRIPTION

A continuous lignin fiber including carbon nanotubes dispersed therein is described. The fiber may be produced by melt spinning and is advantageously employed as a precursor for carbon fiber production. The motivation for adding carbon nanotubes to lignin comes from the idea that the mechanical, thermal, and/or other properties of the resulting carbon fiber may be enhanced by carbon nanotube reinforcement. Unexpectedly, the present inventors have found that the melt spinning of lignin fibers is markedly improved with the addition of a small amount of carbon nanotubes, which vastly increase the green strength of the fibers.

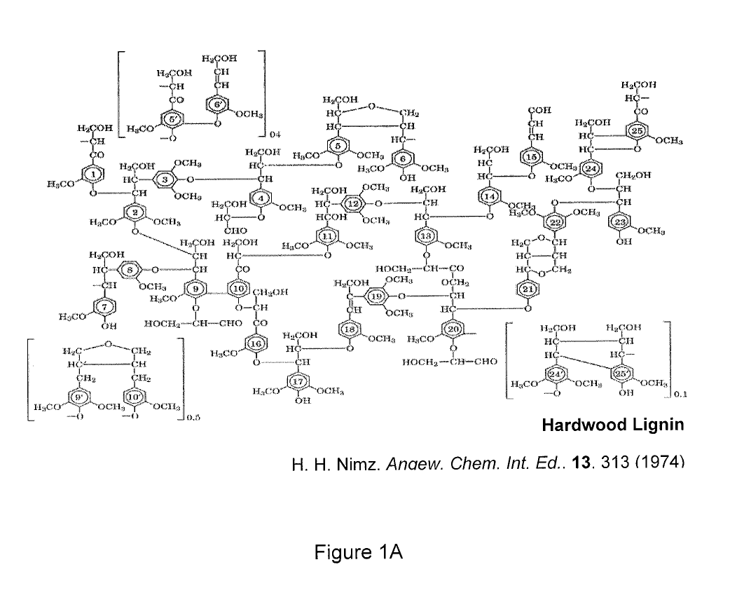

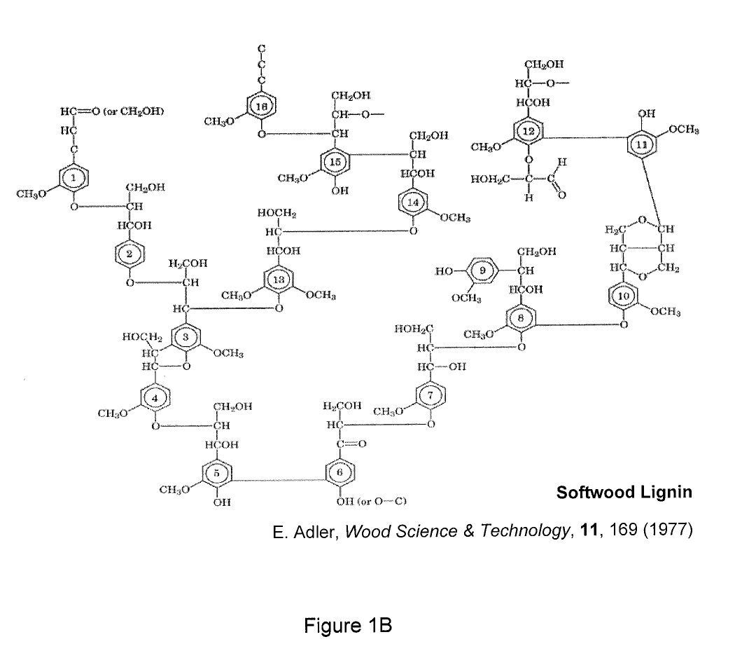

Lignin is one of the main components of all vascular plants and the second most abundant polymer in nature, after cellulose. An example of the complex structure of lignin is shown in FIG. 1A for lignin isolated from beech hardwood. Lignin isolated from hardwoods (HWL) is composed of coniferyl alcohol and sinapyl alcohol units in varying ratios, whereas lignin isolated from softwoods (SWL) predominantly comprises coniferyl alcohol (>90%) and a small proportion of p-coumaryl alcohol, as indicated in FIG. 1B. A lignin fiber produced by melt spinning may be converted into a carbon fiber by a complex process that entails oxidation, carbonization, and graphitization.

A carbon nanotube is a cylindrical arrangement of carbon atoms generally having the form of a sheet of graphene (graphite layer) that has been rolled into a cylinder. Carbon nanotubes were first discovered in 1991 by a researcher at NEC in Japan, and since then have been found to have enhanced physical and electronic properties compared to conventional carbon fibers and other high performance materials. For example, a single wall carbon nanotube has a room-temperature axial thermal conductivity that is about nine times greater than that of copper. Carbon nanotubes also exhibit the highest values of tensile strength and elastic modulus known for any material. The diameter of individual carbon nanotubes, which may be single wall or multiwall structures, is typically in the range of single nanometers.

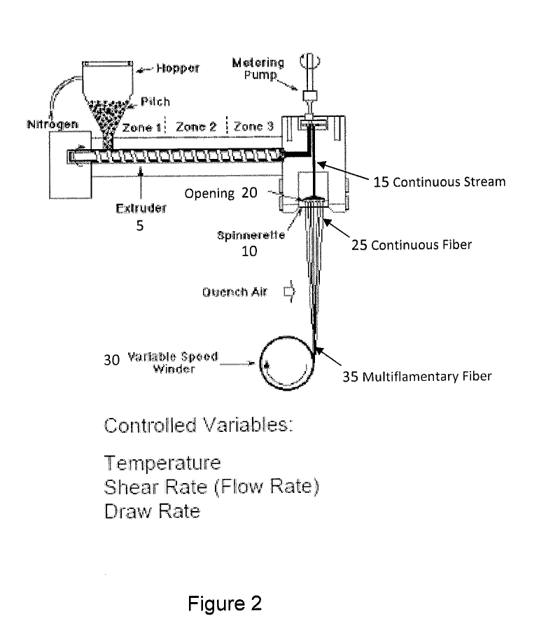

As mentioned above, the inventive lignin fibers that include carbon nanotubes (CNTs) dispersed therein are expected to yield, upon conversion, CNT-reinforced carbon fibers that have improved properties compared to conventional carbon fibers. Furthermore, the processing of a lignin fiber by melt spinning is found to be improved by including carbon nanotubes in the melt. The preparation of a continuous lignin fiber including carbon nanotubes dispersed therein is described here in reference to FIG. 2.

First, a melt including molten lignin and a desired amount of carbon nanotubes is prepared. Generally, the melt includes about 10 wt. % carbon nanotubes or less, and more typically, about 5 wt. % carbon nanotubes or less. For example, the melt may include between about 0.1 wt. % and about 5 wt. % carbon nanotubes. The melt may also include between about 0.5 wt. % and about 1.5 wt. % carbon nanotubes. Single wall and/or multiwall carbon nanotubes may be included in the melt, although multiwall carbon nanotubes are preferred. The carbon nanotubes employed in experiments described in the present disclosure were synthesized at Oak Ridge National Laboratory. Suitable carbon nanotubes may also be obtained from Hyperion Catalysis International (Cambridge, Mass.) or Carbon Solutions, Inc. (Riverside, Calif.).

Typically, lignin and the carbon nanotubes are heated to a temperature of at least about 150° C. to form the melt. Referring to the exemplary melt spinning apparatus 1 shown in FIG. 2, the melt is delivered through an extruder 5 and a spinneret 10 as a continuous stream 15 of molten material. Upon exiting the spinneret 10, which typically has one or more openings 20 of between about 150-250 microns in diameter each, the continuous stream 15 cools and solidifies, forming a continuous fiber 25. The melt is extruded through the spinneret 10 continuously over a desired time period to form a long length of the continuous fiber 25.

Kept under tension, the continuous fiber 25 is drawn down from a larger starting diameter to a smaller final diameter, where the final diameter is typically at least about 5 times smaller than the starting diameter, and may be at least about 10 times smaller than the starting diameter, or at least about 15 times smaller than the starting diameter. The drawn fiber is wound on a spool 30 at a winding speed that typically exceeds 600 m/min, and may exceed 1200 m/min, as will be discussed further below. Typically, the spool 30 is situated a distance of about two meters from the spinneret 10.

The final diameter of the fiber 25 is determined by the diameter of the spinneret opening 20 as well as the extent to which the fiber 25 is drawn down after melt spinning while it is still in the plastic state. For example, the fiber may exit the spinneret at a diameter of about 150 microns and be drawn down to a diameter of about 10 microns. In general, the starting diameter may be between about 150 and 250 microns, and the final diameter may be between about 1 micron and about 50 microns. For example, the final diameter may be between about 1 micron and 20 microns, or between about 5 microns and 15 microns. The drawing down of the fiber achieves not only a reduction in fiber diameter, but also an alignment of the carbon nanotubes and the molecular structure of the fiber along the longitudinal axis.

Ideally, the spinning proceeds continuously for many hours to produce a long length of lignin fiber having the desired drawn diameter and aligned microstructure. The time duration of the process using laboratory-scale equipment is generally at least about four hours, and during that time the resulting fiber may reach 300 km or more in length. Referring again to FIG. 2, the lab-scale spinneret 10 may include multiple openings 20 to continuously and simultaneously spin multiple continuous fibers (filaments) 25 that may be combined to yield a multifilamentary fiber 35. For example, a multifilamentary fiber may include 6 or more individual fibers, 12 or more individual fibers, 18 or more individual fibers, or 24 or more individual fibers. Using commercial-scale melt spinning equipment, a multifilamentary fiber including thousands of individual fibers (e.g., at least about 1000 individual fibers) may be spun for an indefinite time duration (e.g., at least about 40 hours). During commercial-scale operations, thousands of kilometers of fiber may be produced in a continuous process.

The axial alignment that occurs during drawing may be further enhanced, if the lignin fiber remains sufficiently warm and plastic, during winding of the fiber over the spool. Preferably, the axial alignment and concentration of the nanotubes are sufficient to reach the percolation threshold along the length of the lignin fiber. For the purposes of this disclosure, “reaching the percolation threshold along the length of the lignin fiber” means that the carbon nanotubes form a continuous conductive path from one end of the fiber to the other. Having longitudinally aligned carbon nanotubes in lignin in an amount sufficient to reach the percolation threshold may enable the fabrication of carbon fibers with excellent directional thermal and electrical conductivity.

Typically, the concentration of the carbon nanotubes in the continuous lignin fiber formed by melt spinning is about 10 wt. % or less, or about 5 wt. % or less. For example, the concentration of the carbon nanotubes in the lignin fiber may be between about 0.1 wt. % and about 5 wt. %. The concentration may also be between about 0.5 wt. % and about 1.5 wt. %.

The spinning process may be interrupted by breakage of one or more of the fibers, which are under tension during drawing and winding. In conventional melt spinning of lignin (without carbon nanotubes), the molten stream cools rapidly upon exiting from the spinneret. In a typical process, the lignin stream exits the spinneret at a temperature of about 200° C. and is cooled to room temperature in a fraction of a second, forming a solid lignin fiber within centimeters of the spinneret. Since lignin loses plasticity when cooled, particularly below the glass transition temperature (T_{g}), the likelihood of fracture during drawing or winding may increase.

However, when carbon nanotubes (CNTs) are included in the lignin melt, the molten stream cools much more slowly upon exiting the spinneret. The inventors have observed that the CNT-reinforced lignin fiber remains warm to the touch (e.g., at a temperature of about 40° C.) for about 5 minutes or more as an increasing length of fiber is wound about the spool. The continuous fiber formed by melt spinning may remain at a temperature above that of the surrounding environment for the duration of the drawing and winding process.

Because of the increased heat capacity of the carbon nanotube-reinforced lignin, the melt spinning process can proceed not only longer, but also faster. In the melt-spinning of lignin without carbon nanotubes, winding typically occurs at speeds of about 600 m/min. When carbon nanotubes are added to the melt, the winding speed may be increased to about 1500 m/min or higher. At such high winding speeds, a longer length of the desired diameter of drawn fiber may be obtained in a shorter time period and the melt spinning operation may be sustained for a much longer time period without breakage of the fiber at the spinneret face. The carbon nanotubes appear to act as a lubricant during the melt spinning process.

A great deal of previous work has focused on the processing of lignin (pre-melt spinning) to remove unwanted contaminants, such as ash, organic volatiles, and non-melting particulates. Purified forms of lignin, such as solvent-extracted hardwood lignin, are advantageously employed for the melt spinning. It has been found that softwood lignin can be used for the melt spinning when combined with a purified hardwood lignin as a plasticizing agent. Advantageously, the lignin employed for the melt spinning includes less than about 5 wt. % volatiles measured at 250° C., less than about 1000 ppm ash, and less than about 500 ppm non-melting particulates of greater than 1 micron in size. Ash is the material leftover as residue from the combustion of lignin.

Following a series of processing steps that may include oxidation, carbonization, and graphitization, the CNT-reinforced lignin fiber can be transformed to a carbon fiber including a dispersion of axially-aligned carbon nanotubes. During processing, the lignin shrinks and effectively tightens around the dispersed carbon nanotubes, which leads to better adhesion between the resulting carbon fiber matrix and the nanotube reinforcements. This is important in terms of mechanical properties, as poor adhesion between the matrix and reinforcing fiber is known to be a cause of failure in composite materials.

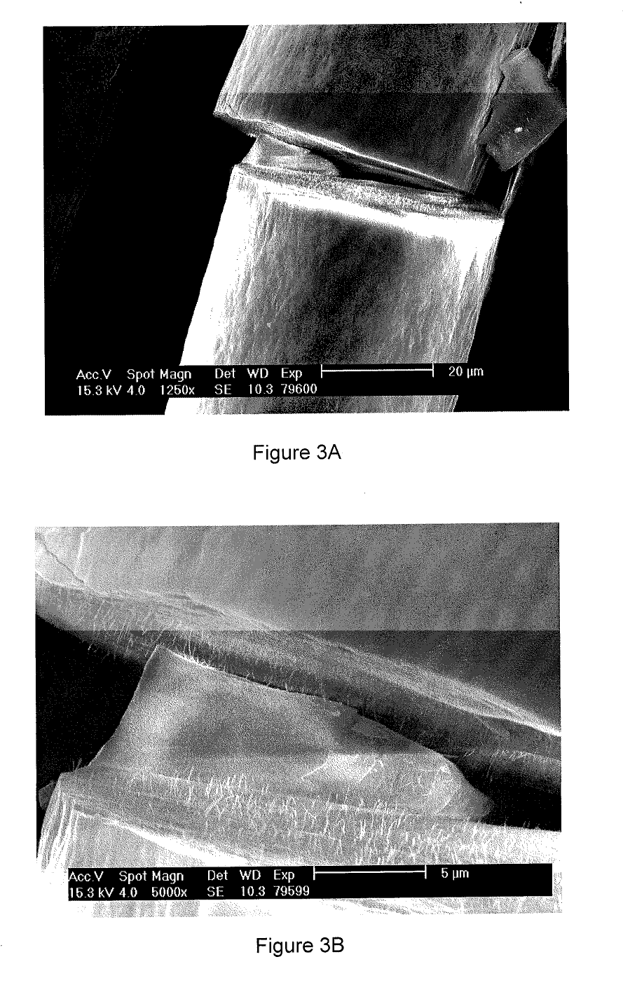

Qualitative evidence of enhanced electrical conductivity in lignin fibers reinforced with carbon nanotubes has been obtained by way of the scanning electron micrograph (SEM) images presented in FIGS. 3A and 3B. The images were obtained without coating the lignin fibers with a conductive metal (e.g., gold) which is generally required to view nonconductive materials without charging effects. The images demonstrate the conductivity imparted to the lignin fibers by a small mass fraction of carbon nanotubes. The enhancement in conductivity (both electrical and thermal) is believed to be highly anisotropic, where the conductivity is enhanced along the axis of the fibers due to the alignment of the nanotubes in the longitudinal direction.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A precursor for carbon fiber production, the precursor comprising:
a continuous lignin fiber including carbon nanotubes dispersed therein at a concentration of about 10 wt. % or less.

2. The precursor of claim 1 wherein the concentration of the carbon nanotubes is about 5 wt. % or less.

3. The precursor of claim 2 wherein the concentration of the carbon nanotubes is between about 0.5 wt. % and 1.5 wt. %.

4. The precursor of claim 1 wherein the carbon nanotubes are substantially aligned along a longitudinal axis of the lignin fiber.

5. The precursor of claim 1 wherein the concentration and alignment of the carbon nanotubes is sufficient to reach a percolation threshold of the carbon nanotubes along a length of the lignin fiber.

6. The precursor of claim 1 wherein the carbon nanotubes include multiwall carbon nanotubes.

7. The precursor of claim 1, wherein the lignin fiber comprises a diameter of between about 1 micron and 50 microns.

8. The precursor of claim 1 wherein the lignin fiber comprises less than about 5 wt. % volatiles measured at 250° C.

9. The precursor of claim 1 wherein the lignin fiber comprises less than about 1000 ppm ash.

10. The precursor of claim 1 wherein the lignin fiber comprises less than about 500 ppm non-melting particulates of greater than 1 micron in size.

11. The precursor of claim 1 wherein the lignin fiber comprises hardwood lignin and softwood lignin.

12. A method of melt-spinning a continuous lignin fiber, the method comprising:
preparing a melt comprising molten lignin and a plurality of carbon nanotubes;
extruding the melt through a spinneret to form a continuous lignin fiber having the carbon nanotubes dispersed therein.

13. The method of claim 12 wherein the melt includes about 10 wt. % carbon nanotubes or less.

14. The method of claim 12 wherein the melt is extruded through the spinneret continuously over a time period of at least about 4 hours.

15. The method of claim 14 wherein the time period is at least about 40 hours.

16. The method of claim 12 further comprising drawing the continuous lignin fiber down from a first diameter to a second diameter, the second diameter being at least about 10 times smaller than the first diameter.

17. The method of claim 12 further comprising aligning the carbon nanotubes along a longitudinal axis of the continuous lignin fiber.

18. The method of claim 12 further comprising winding the continuous lignin fiber on a spool.

19. The method of claim 18 wherein the winding occurs at a speed of at least about 1200 m/min.

20. The method of claim 19 wherein the winding occurs at a speed of at least about 1500 m/min.

21. The method of claim 12, wherein the continuous fiber remains at a temperature above that of the surrounding environment for at least about 5 minutes after being formed.
